(19) United States
(12) Patent Application Publication
(10) Pub. No.: US 2009/0058801 A1
(43) Pub. Date: Mar. 5, 2009

(54) FLUID MOTION USER INTERFACE CONTROL

(75) Inventor: William Bull, Cupertino, CA (US)

Correspondence Address: APPLE c/o MOFO NOVA, 1650 TYSONS BLVD., SUITE 300, MCLEAN, VA, 22102, US

(73) Assignee: Apple Inc., Cupertino, CA (US)

(21) Appl. No.: 11/849,801

(22) Filed: Sep. 4, 2007

(51) Int. Cl. G06F 3/033

(52) U.S. Cl. 345/157

(57) ABSTRACT

A fluid motion user interface control is disclosed. According to an example of the disclosure, a processor receives a signal indicating a unit of motion applied to an input device, determines a distance to move a cursor based on the unit of motion, and displays a movement of the cursor over the distance in two or more stages.

### FIELD OF THE DISCLOSURE

The disclosure of the present application relates to graphical user interfaces, and more particularly, to providing effective user interface controls.

### BACKGROUND

A graphical user interface, commonly known as a GUI, is the mechanism by which most people interact with and control computer-based devices. In most cases, a GUI relates to the particular type of display that a device provides on a screen, and the manner in which a user of the device is able to manipulate the display in order to control the device. Common elements of a GUI include windows, icons, menus, buttons, cursors and scroll bars for example.

Navigation controls, such as cursors, menus and buttons, are important elements of a GUI because they define how the user is able to manipulate the display. A key navigation control is the cursor, which is a visible pointer or highlighted region that indicates a position in the display. Known types of cursors include a mouse pointer, a highlighted region that scrolls between various menu options, and a vertical bar or underscore that indicates where text is ready for entry in many word processing applications.

Cursor movement in a display is directed by a user through movement applied to one or more input devices, such as a mouse, touchpad or keyboard. For example, the user can control the movement of a mouse pointer in a computer display by moving a mouse or sliding the user's finger along a touchpad in a desired direction. The user can control the movement of a text entry cursor by pressing the left and right arrow keys on a keyboard.

The effectiveness of a GUI depends on its ability to meet a user's expectation of how an action by the user, captured through an input device, translates into a resulting action in the display. A GUI that provides an unexpected action in the display responsive to the user's input may cause user annoyance and frustration. An unexpected action in the display may also cause the device to perform in an unintended and potentially damaging manner.

### SUMMARY

In order to improve the effectiveness of a GUI, methods of the present disclosure impart visual and functional behavior to a user interface control that better meets a user's expectation of user interface control behavior. The imparted visual and functional behavior provide the user with a sense of more control between the user's input actions and the resulting actions of the user interface control.

For example, in translating rotational movement provided by a user through an input device into cursor navigation between discrete objects in a list, the methods of the present disclosure may impart a fluid and continuous motion to the cursor's movement rather than simply switching the cursor position from one object to the other. The fluid and continuous motion may provide visual effects to the cursor's movement such as acceleration, deceleration and gravity snapping.

For example, when user input indicates that the user is expecting the cursor to advance to the next object, the cursor movement can initially accelerate and then decelerate as it approaches the next object. When the cursor comes within a certain distance of the object, it can be quickly drawn to the object with a gravity snapping effect.

In a situation in which user input indicates that the user is not expecting the cursor to advance to the next object, such as an accidental touch of the input device causing the cursor to move a short distance from an object, the gravity snapping effect may draw the cursor back to the object to remedy the accidental touch.

The methods of the present disclosure may also adjust a size of the cursor as it navigates between discrete objects of different sizes, such that the cursor size corresponds to the size of the object it's highlighting. An adjustable cursor size allows objects to be displayed closer together, since each object would not require spacing to accommodate a fixed-size cursor. This is advantageous, for example, in devices that have small screens, because it allows more objects to be displayed in a smaller display space.

### BRIEF DESCRIPTION OF THE DRAWINGS

FIG. 1 is a diagram of an example of a device with a display and rotational input area.

FIG. 2 is a diagram of an example of discrete cursor movement associated with a rotational input area.

FIG. 3 is a diagram of an example of fluid cursor movement associated with a rotational input area.

FIG. 4 is a flow chart of an example of an algorithm applying fluid cursor movement.

FIG. 5 is a diagram of an example of fluid cursor movement.

FIG. 6 is a diagram of an example of two movement ranges associated with fluid cursor movement.

FIG. 7 is a flow chart of an example of an algorithm applying fluid cursor movement among two movement ranges.

FIG. 8 is a plot of an example of a rate of fluid cursor movement.

FIG. 9 is a diagram of an example of fluid cursor movement with an adjustable cursor size.

FIG. 10 is a screenshot of an example of a black lozenge slider overlay.

FIGS. 11A and 11B are screenshots of examples of black lozenge slider overlays.

FIGS. 12A and 12B are screenshots of examples of white lozenge slider overlays.

FIGS. 13A, 13B and 13C are screenshots of examples of white lozenge slider overlays.

FIG. 14 is a diagram of an example of device components.

### DETAILED DESCRIPTION

The present disclosure teaches the use of visual and functional behavior to a user interface control that better meets a user's expectation of user interface control behavior. The visual and functional behavior provides the user with a sense of more control between the user's input actions and the resulting actions of the user interface control.

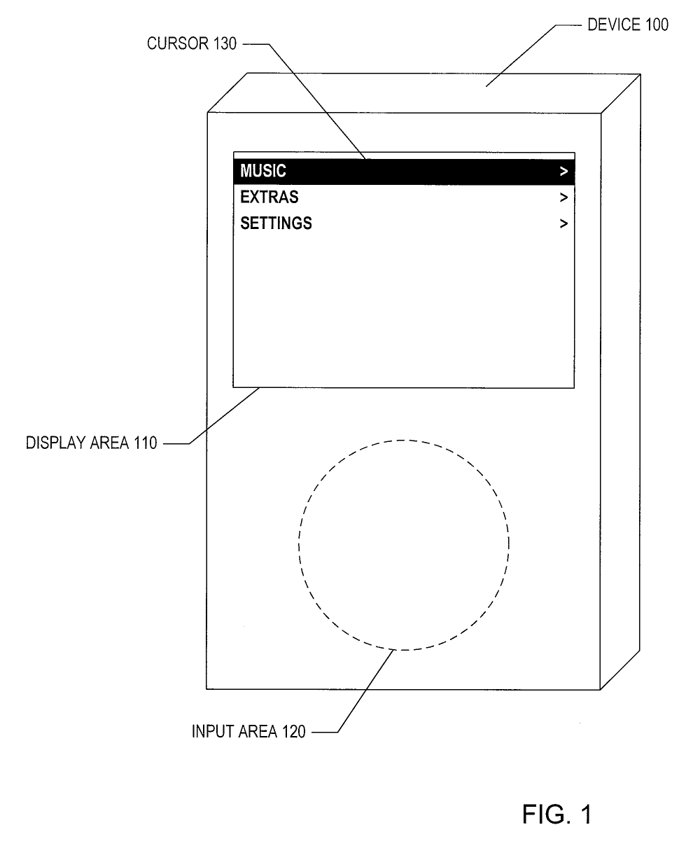

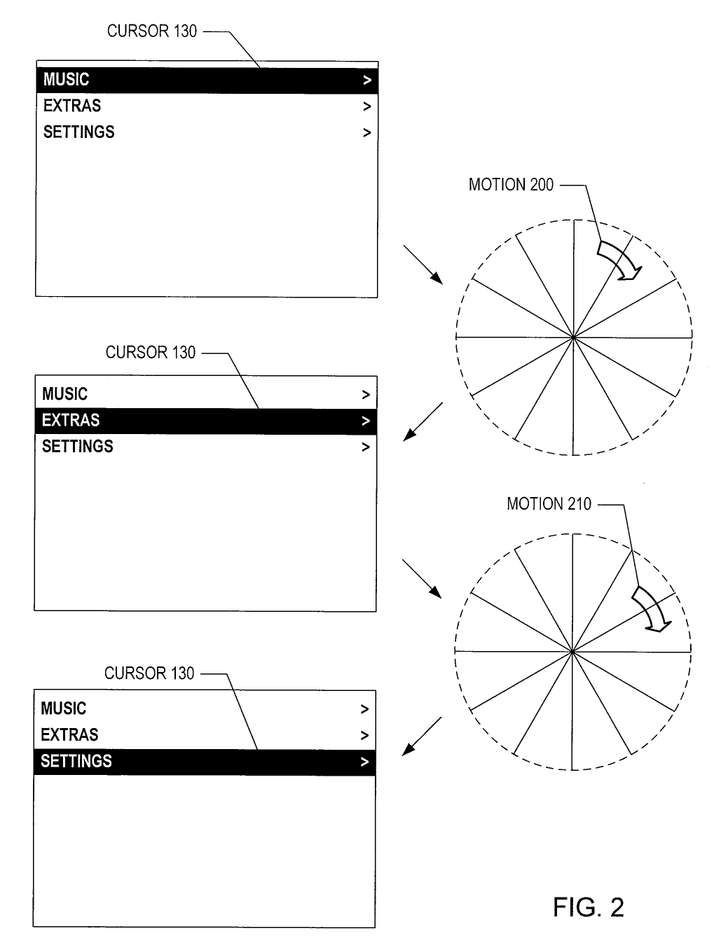

An example of a perceived lack of control provided by user interface control behavior is portrayed in FIGS. 1 and 2. FIG. 1 is an example a device utilizing a menu-based GUI directed by a scroll wheel input device. Device 100 includes display area 110 in which the GUI is displayed, and input area 120 in which rotational motion is provided by a user. The GUI displays a menu of selectable items identified as “music” “extras” and “settings”. Cursor 130 highlights the “music” item in the GUI.

FIG. 2 is an example of discrete cursor movement associated with rotational motion provided to a scroll wheel in input area 120. When the scroll wheel detects user motion 200 crossing from a first region into a second region, the scroll wheel sends a signal to the processor of device 100 indicating that one unit (or “tick”) of motion has been detected in the clockwise direction.

In response, the processor changes the display to reflect cursor 130 switching from highlighting the “music” item to highlighting the “extras” item. Similarly, when the scroll wheel detects user motion 210 crossing from the second region into a third region, a similar signal is sent and the cursor 130 is switched from highlighting the “extras” item to highlighting the “settings” item. If the user motion was detected in a counter-clockwise motion, then the scroll wheel signal would specify the reverse direction, and the processor would traverse the list upward one element at a time, rather than downward.

The discrete cursor movement in this example provides a perceived lack of control between the user's input actions and the resulting actions of the user interface control because a fluid and continuous motion provided by a user is translated into a jerky and disconnected switching of highlighted items in the GUI. Such behavior makes it difficult for a user to get a proper sense for the amount of rotational motion required to navigate a cursor from one item to another.

For example, if the user does not apply enough of a rotational motion to the scroll wheel, the cursor will simply remain in it's current position and offer no indication that it has recognized the user's attempt to traverse the list of items. On the other hand, if the user applies too much of a rotational motion to the scroll wheel, the cursor will hop past the user's desired selection and require the user to carefully manipulate the scroll wheel to bring the cursor back to the desired position.

Accordingly, the application of fluid and continuous motion to the cursor's movement in response to the user's rotational motion input provides the user with a better sense of control over the GUI.

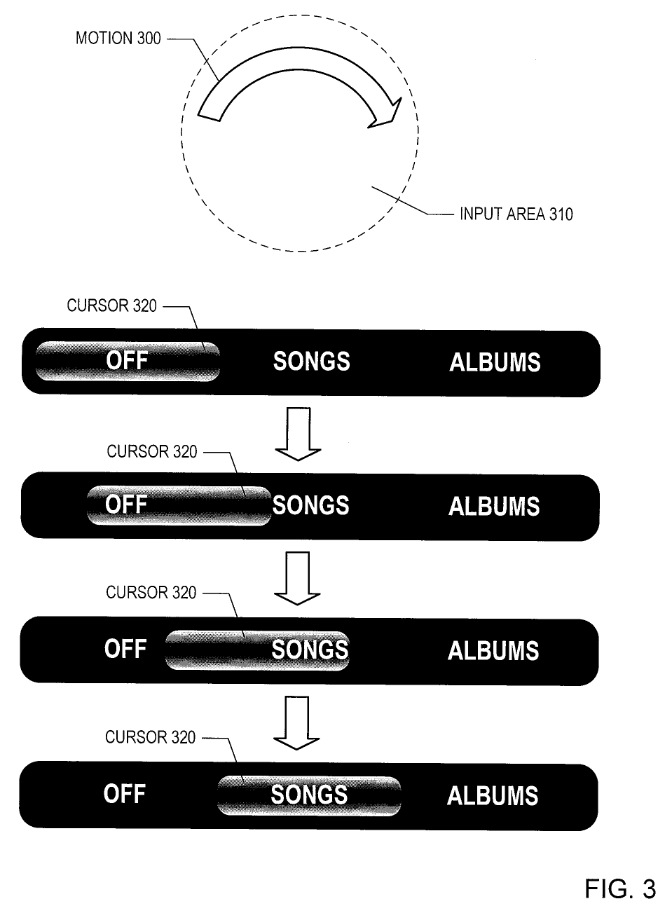

FIG. 3 is an example of fluid cursor movement associated with a rotational input area. In this example, cursor 320 navigates between selectable items “off”, “songs” and “albums” as displayed in a GUI. When a user applies motion 300 to input area 310, cursor 320 advances with a fluid and continuous motion from highlighting the “off” item to highlighting the “songs” item.

Due to static illustration limitations, FIG. 3 shows only two states of the cursor progression between its starting and ending positions. However, in actuality the cursor advances in steps small enough, and at a rate fast enough, to provide the cursor movement with a visual effect of fluid motion. Although the cursor movement is horizontal in this particular item navigation application, the present disclosure is not limited to horizontal cursor movement. Rather, vertical or any other direction or path of movement may be applied in accordance with the teachings of the present disclosure.

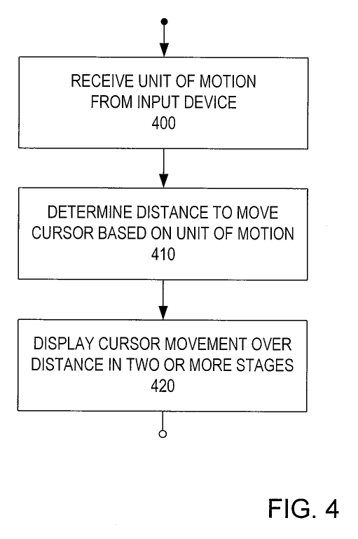

FIG. 4 provides a flow chart of an example algorithm for applying fluid cursor movement to a user interface control. At step 400, a processor may receive a signal indicating a unit of motion applied to an input device, and at step 410, the processor may determine a distance to move a cursor based on the unit of motion. At step 420, the processor displays a movement of the cursor over the distance in two or more stages to provide a visual effect of fluid motion.

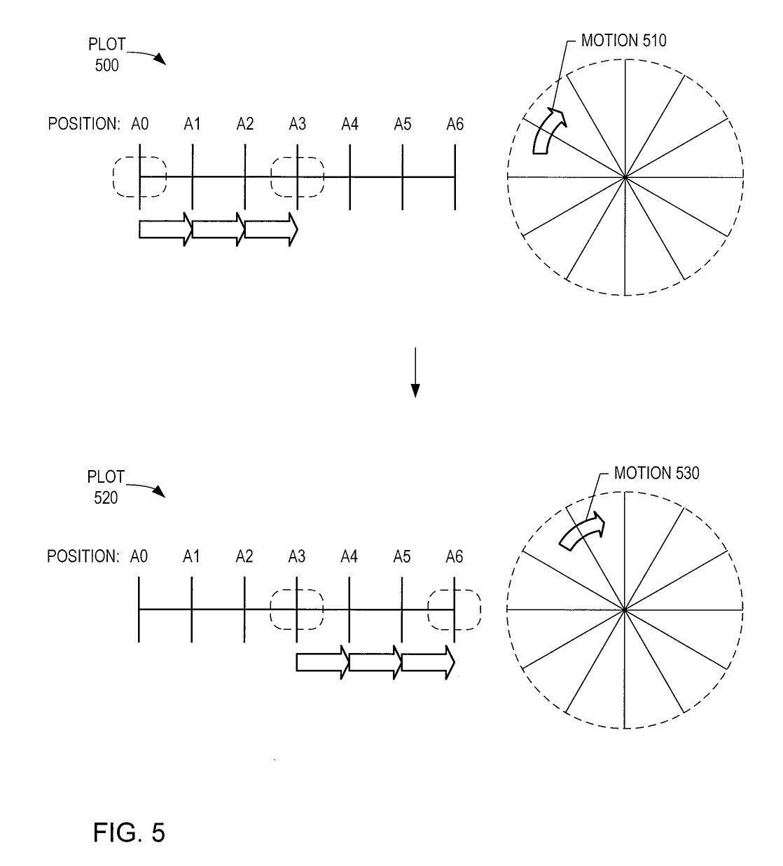

An example implementation of this process is shown in FIG. 5. In this example, plot 500 illustrates cursor movement provided when motion 510 is captured by a scroll wheel input device, and plot 520 illustrates the cursor movement provided when motion 530 is captured by the scroll wheel input device.

When the scroll wheel detects user motion 510 crossing from a first region into a second region, the scroll wheel sends a signal to a processor indicating that one unit of motion has been detected in the clockwise direction. In response, the processor determines that the distance to move the cursor corresponding to one unit of scroll wheel detection is the distance from position A0 to A3. The processor then displays cursor movement over that distance in three stages—movement of the cursor from position A0 to position A1, from position A1 to position A2, and from position A2 to position A3.

Similarly, for the next received unit of scroll wheel detection based on motion 530, the processor determines that the corresponding distance to move the cursor is the distance from position A3 to A6. The processor then displays the cursor movement over that distance in three stages—movement of the cursor from position A3 to position A4, from position A4 to position A5, and from position A5 to position A6.

Due to static illustration limitations, the number of display stages corresponding to motion 510 and 530 are shown as three, but in actuality this number may be much greater. For example, the number of display stages and the rate at which the cursor is displayed at each stage may be based on a number and rate that provide the cursor movement with a visual effect of fluid motion over the determined distance. The effect of fluid motion provides the user with visual reinforcement that the user's input motion has been recognized and is resulting in an expected action of the cursor.

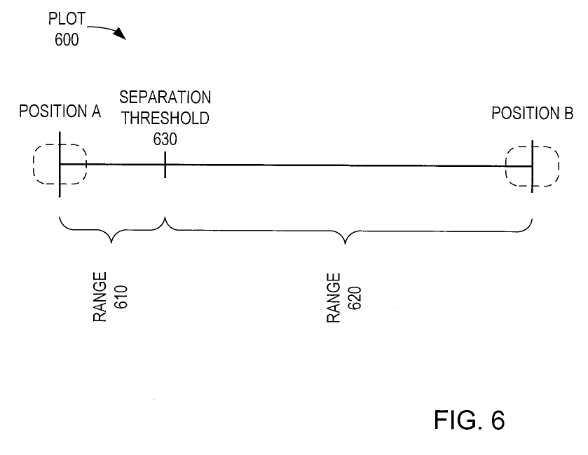

In connection with the example of FIG. 3, the starting and ending positions associated with each determined cursor movement distance could relate to positions of the items in the list being navigated, or any position in between, depending on how many detected scroll wheel units a particular GUI may be configured to require for the cursor to leave one item and arrive at the next. The amount of distance determined to correspond to each unit of scroll wheel detection depends on the particular application and desired visual effect, as described in the examples associated with FIGS. 6-8 below.

FIG. 6 is an example of two movement ranges that may individually or in combination provide visual and functional behavior to cursor navigation control. In this example, plot 600 illustrates a cursor navigation distance between position A and position B. The distance between position A and separation threshold position 630 defines movement range 610, and the distance between threshold position 630 and position B defines movement range 620.

Range 610 is directed to a navigation distance within which the cursor may be returned to position A if subsequent user input for moving the cursor is not provided within a predetermined time-out period since prior input for advancing the cursor was received. A fluid and continuous effect, such as a gravity snapping effect for example, may be applied to return the cursor to position A during this period. Range 620 is directed to a navigation distance within which no further user input may be required in order to move the cursor to position B. A fluid and continuous effect, such as an acceleration and/or deceleration effect for example, may be applied to move the cursor to position B during this period.

For example, in an item navigation application in which a cursor navigates between an item located at position A and an item located at position B, a GUI may require two units of input motion to be detected in order to move the cursor from position A to threshold position 630, and one additional unit to move the cursor past threshold position 630 and the remainder of the distance to position B.

If two units of motion are initially detected within range 610 without a third unit detected within a predetermined time-out period thereafter, the cursor movement may be moved off position A for a part of the distance to position 630—in an acknowledgment of the detected input motion—but will subsequently be drawn back to position A as if pulled back by gravity. This gravity snapping effect may prove advantageous to remedy against accidental touches of an input device, while providing the user with a visual indication that the input device detected a motion.

If the third unit is detected within the time-out period, then the cursor may be moved to position B without further user input. This cursor movement may be characterized by a period of initial acceleration and subsequent deceleration as the cursor approaches position B. When the cursor approaches a predetermined distance from position B, it may snap to position B in accordance with the gravity snapping effect described above. This acceleration/deceleration effect may prove advantageous to remedy against a user navigating past a desired item in a list due to sensitivity issues as described above in connection with FIGS. 1 and 2.

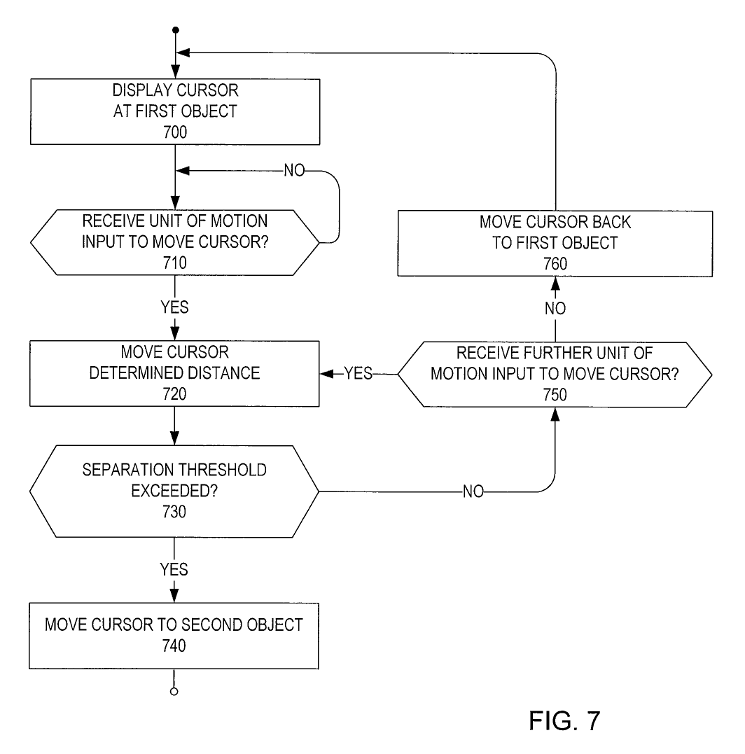

FIG. 7 is a flow chart of an example of an algorithm applying fluid cursor movement among movement ranges 610 and 620. In this example, a processor may display a cursor at a first object at step 700, and wait until a unit of motion input is received for moving the cursor at step 710. When a unit of motion input is received, the processor may move the cursor at step 720 in a manner as described in connection with step 420 above for a distance as determined in connection with step 410 above.

If the cursor movement moves the cursor past threshold position 630, then at step 740 the processor may move the cursor the remainder of the distance to the second object, for example, in accordance with the acceleration/deceleration effect described above. If the cursor movement does not move the cursor past threshold position 630, then at step 750 the processor may wait to receive a further unit of motion input within a predetermined time-out period. If the further unit of motion input is received within the time-out period, then the processor may return to the flow process at step 720. If the further unit of motion input is not received within the time-out period, then at step 760 the processor may move the cursor back to the first object, for example, in accordance with the gravity snapping effect described above.

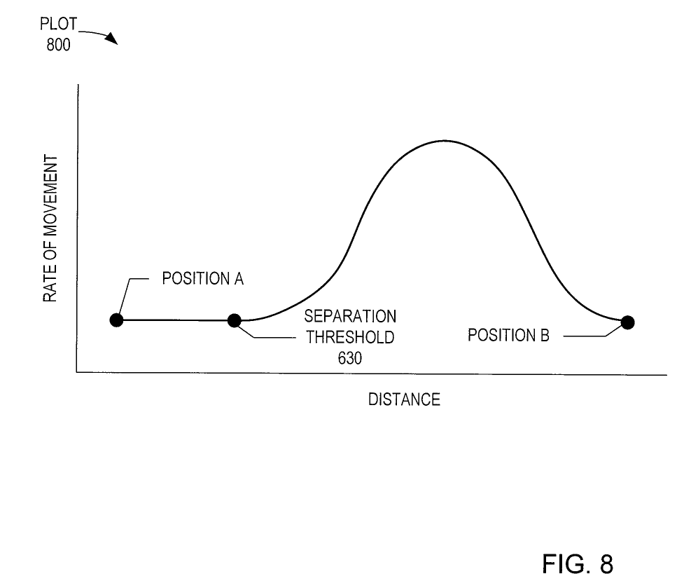

FIG. 8 is a plot of an example of a rate of fluid cursor movement that may be applied among ranges 610 and 620. In this example, during range 610 a linear rate of movement may be applied to the cursor when advanced by the appropriate amount of user input, and during range 620 a non-linear rate of movement may be applied to the cursor indicating, for example, an acceleration and subsequent deceleration of the cursor movement as it approaches position B.

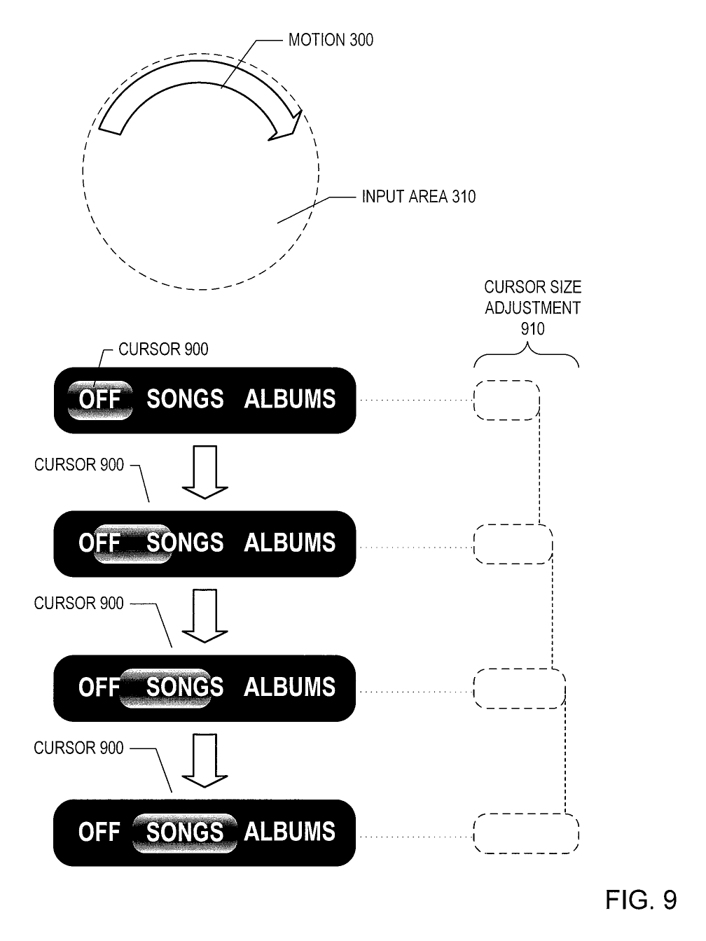

FIG. 9 is a diagram of an example of fluid cursor movement with an adjustable cursor size. In this example, cursor 900 navigates between selectable items “off”, “songs” and “albums” as in FIG. 3, except that the widths of the items are not uniform. More particularly, the width of the item “off” is shorter than the width of the items “songs” and “albums”. As shown by cursor size adjustment 910, the size of cursor 900 adjusts as it navigates between item “off” and item “songs” so that the cursor size may correspond to the size of the item it's highlighting. An adjustable cursor size allows items to be displayed closer together, since each item would not require spacing to accommodate a fixed-size cursor. This is advantageous, for example, in devices that have small screens, because it allows more objects to be displayed in a smaller display space.

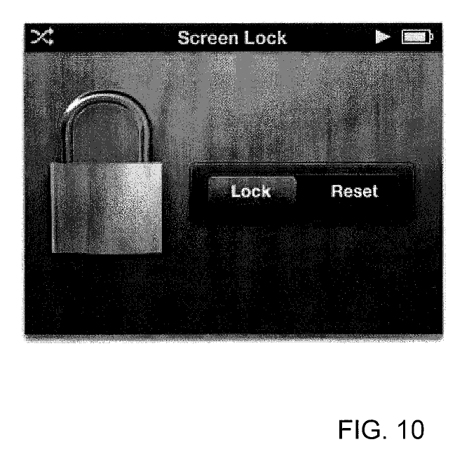

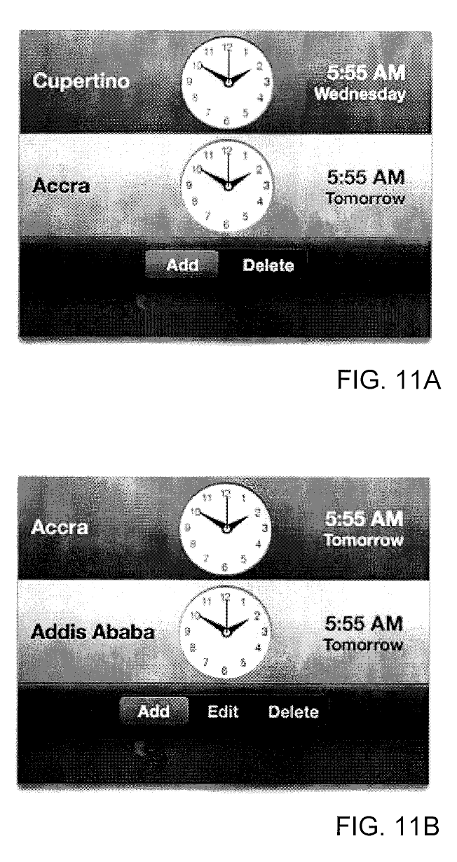

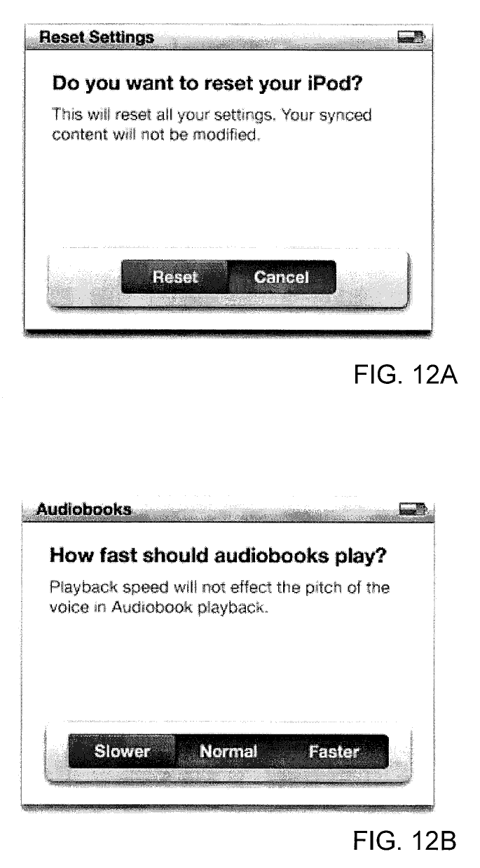

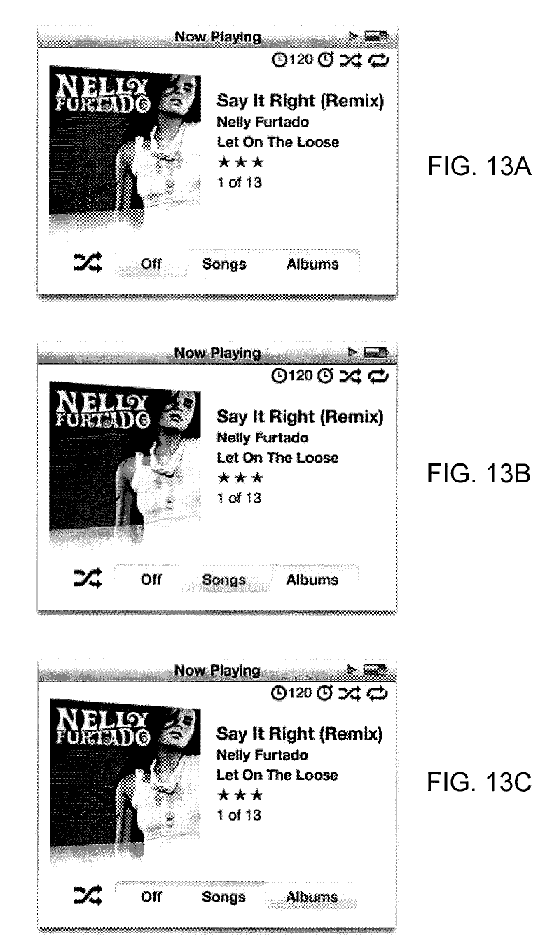

FIGS. 10-13 are screenshots of examples of button-style slider navigation control overlays. FIGS. 10, 11A and 12A illustrate two-option sliders, while FIGS. 11B, 12B, 13A, 13B and 13C illustrate three-option sliders. The sliders in FIGS. 10, 11A and 11B are associated with black lozenge-shaped overlays, while the sliders in FIGS. 12A, 12B, 13A, 13B and 13C are associated with white lozenge-shaped overlays.

The sliders in these figures are colored or shaded in a contrasting manner to the options they highlight in order to provide an effective visual display. As shown in the sliders of FIGS. 10, 11A, 11B, 12A and 12B, the appearance of the options remain the same whether or not they are being highlighted by the sliders. In FIGS. 13A, 13B and 13C, the appearance of the options changes when highlighted by the slider, but only by a color or shade in the same tonal range as the options' non-highlighted color or shade.

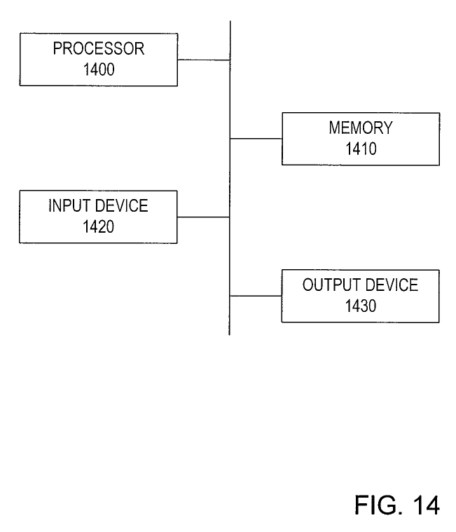

FIG. 14 depicts an example of components of a device that may be utilized in associated with the subject matter discussed herein. In this example, the device components include processor 1400, memory 1410, input device 1420 and output device 1430.

Processor 1400 may be configured to execute instructions and to carry out operations associated with the device. For example, using instructions retrieved for example from memory 1410, processor 1400 may control the reception and manipulation of input and output data between components of the device. Processor 1400 may be implemented on a single-chip, multiple chips or multiple electrical components. For example, various architectures can be used for processor 1400, including dedicated or embedded processor, single purpose processor, controller, ASIC, and so forth.

Processor 1400 may function with an operating system and/or application software to execute computer code and produce and use data. The operating system may correspond to well known operating systems such as OS/2, DOS, Unix, Linux, and Palm OS, or alternatively to special purpose operating system, such as those used for limited purpose appliance-type devices (e.g., media players). The operating system, other computer code and data may reside within a memory 1410 operatively coupled to the processor 1400. Memory 1410 may provide a place to store computer code and data that are used by the device. By way of example, memory 1410 may include read-only memory (ROM), random-access memory (RAM), hard disk drive and/or the like.

Output device 1430, such as a display for example, may be operatively coupled to processor 1400. Output device 1430 may be configured to display a GUI that provides an interface between a user of the device and the operating system or application software running thereon. Output device 1430 may include, for example, a liquid crystal display (LCD).

Input device 1420, such as a scroll wheel or touch screen, for example, may be operatively coupled to processor 1400. Input device 1420 may be configured to transfer data from the outside world into the device. Input device 1420 may for example be used to make selections with respect to a GUI on output device 1430. Input device 1420 may also be used to issue commands in the device. A dedicated processor may be used to process input locally to input device 1420 in order to reduce demand for the main processor of the device.

The components of the device may be operatively coupled either physically or wirelessly, and in the same housing or over a network. For example, in an example where each component does not reside within a single housing, input device 1420 may include a remote control device and output device 1430 may include a television or computer display.

Although the claimed subject matter has been fully described in connection with examples thereof with reference to the accompanying drawings, it is to be noted that various changes and modifications will become apparent to those skilled in the art. Such changes and modifications are to be understood as being included within the scope of the present disclosure as defined by the appended claims.

For example, the present disclosure is not limited to motion captured by scroll wheel input devices, but rather applies to any user input captured by any input device that is processed in accordance with the teachings of the present disclosure for better meeting a user's expectation of user interface control behavior. Further, the present disclosure is not limited to the item navigation application disclosed herein, but rather applies to user interface control behavior associated with any type of object (e.g., text, icon, image, animation) that may be highlighted in accordance with the teachings of the present disclosure.

What is claimed is:

1. A method comprising:
receiving a signal indicating a unit of motion applied to an input device;
determining a distance to move a cursor based on the unit of motion; and
displaying a movement of the cursor over the distance in two or more stages.

2. The method of claim 1, wherein the unit of motion includes a number of regions of the input device that the motion has crossed.

3. The method of claim 1, wherein the unit of motion includes a direction of the motion.

4. The method of claim 1, wherein the input device includes a scroll wheel.

5. The method of claim 1, wherein the two or more stages of display provide the cursor movement with a visual effect of fluid motion.

6. The method of claim 1, wherein the two or more stages of display provide the cursor movement with a visual effect of acceleration or deceleration.

7. The method of claim 1, wherein the cursor movement is associated with an advancement of the cursor from a first position associated with a first object to a second position associated with a second object.

8. The method of claim 7, wherein the cursor highlights the first object from the first position and highlights the second object from the second position.

9. The method of claim 8, wherein an appearance of the first and second objects is not altered when the cursor is advanced from the first position to the second position.

10. The method of claim 7, wherein the first and second objects include text objects.

11. The method of claim 7, wherein upon reaching a predetermined distance from the second position during the advancement of the cursor, the cursor movement is provided with a visual effect of snapping onto the second object.

12. A method comprising:
displaying a list including a first item and second item of different sizes; and
displaying a movement of a cursor from a position highlighting the first item to a position highlighting the second item, wherein a size of the cursor is adjusted during two or more stages of the movement.

13. The method of claim 12, wherein the size of the cursor is adjusted in relation to the different sizes of the first item and second item.

14. The method of claim 12, wherein the cursor movement is displayed to provide a visual effect of fluid motion.

15. The method of claim 12, wherein the cursor movement is displayed to provide a visual effect of acceleration or deceleration.

16. The method of claim 12, wherein the first and second items include text items.

17. The method of claim 12, wherein the first and second items include icons.

18. A device comprising:
a processor configured to
recognize a command to move a cursor in a specified direction, and
determine a distance to move the cursor responsive to the command; and
an output device configured to display a movement of the cursor over the distance in a plurality of steps.
